(19) United States
(12) Patent Application Publication
(10) Pub. No.: US 2003/0194470 A1
(43) Pub. Date: Oct. 16, 2003

(54) Pecan confection

(76) Inventor: John A. Glover, Wrightville, GA (US)

Correspondence Address: Richard C. Litman, LITMAN LAW OFFICES, LTD., P.O. Box 15035, Arlington, VA, 22215, US

(21) Appl. No.: 10/407,173

(22) Filed: Apr. 7, 2003

Related U.S. Application Data
(60) Provisional application No. 60/371,395, filed on Apr. 11, 2002.

(51) Int. Cl. A23L 1/36

(52) U.S. Cl. 426/93

(57) ABSTRACT

The pecan confectionery according to the present invention comprises two overlapping pecan halves and an edible filling layer sandwiched between the two pecan halves. The filling layer can be any spreadable food product including but not limited to cream, ice cream, marshmallow, and caramel. In addition to enhancing the flavor of the pecan halves, the filling layer serves to hold the pecan halves together. Thus, the arrangement of the pecan confectionery allows one to enjoy a unique combination of flavors in a simple and convenient manner.

### CROSS-REFERENCE TO RELATED APPLICATION

This application claims the benefit of U.S. Provisional Patent Application Serial No. 60/371,395, filed Apr. 11, 2002.

### BACKGROUND OF THE INVENTION

1. Field of the Invention

The present invention relates generally to edible products. More specifically, the present invention relates to pecan confectioneries.

2. Description of the Art

It is common practice to enhance or vary the flavor of nuts by coating each nut with a confection. It is also known that more than one nut is typically consumed at one time. In the past, however, the confection added to nuts and nut products has served primarily as a flavor enhancement and has done little to facilitate consumption of a plurality of nuts at one time.

U.S. Pat. No. 4,501,758, issued Feb. 26, 1985 to C. Morris, discloses nuts which are coated with an aqueous sugar and carbohydrate adhesive material, followed by treatment with a dry, honey-containing mixture.

U.S. Pat. No. 4,522,833, issued Jun. 11, 1985 to S. Sharma, discloses roasted coated nut products. Each nut is roasted, coated with a,sugar syrup, and then roasted again.

U.S. Pat. No. 4,910,028, issued Mar. 20, 1990 to D. Bernacchi et al., discloses roasted nuts having an adherent honey coating. Each nut is coated with nut coater slurry followed by a nut coater mixture, and then roasted.

U.S. Pat. No. 5,362,505, issued Nov. 8, 1994 to Y. Hsieh et al., disclose a method for producing individual, crunch confectionery-coated edible nuts.

None of the above inventions and patents, taken either singly or in combination, is seen to describe the instant invention as claimed.

### SUMMARY OF THE INVENTION

The pecan confectionery according to the present invention has two overlapping pecan halves and an edible filling layer sandwiched between the two pecan halves. The filling layer can be any food product including, but not limited to, cream, ice cream, marshmallow, and caramel. In addition to enhancing the flavor of the pecan halves, the filling layer serves to hold the pecan halves together. Thus, the arrangement of the pecan confectionery allows one to enjoy many pecan nuts and a unique combination of flavors in a simple and convenient manner.

The pecan confectionery may also have an edible outer shell configured to simulate the shell of a pecan. A plurality of pecan confectioneries can also be adhered together by their outer shells to create a desired decorative structure.

Accordingly, it is a principal object of the invention to provide a pecan confectionery which can be readily eaten.

It is another object of the invention to provide a pecan confectionery which has the flavor of a pecan as well as at least one additional flavor.

It is a further object of the invention to provide a pecan confectionery having an outer edible shell.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a perspective view of a pecan confection according to a first embodiment of the present invention.

FIG. 2 is an exploded perspective view of a pecan confection according to a second embodiment of the present invention.

FIG. 3 is a perspective view of a pecan confection cluster composed of confections according to the second embodiment of the present invention formed into the shape of an animal.

FIG. 4 is an environmental perspective view of a pecan confection according to a third embodiment of the present invention.

FIG. 5 is a vertical section view of a pecan confection according to the third embodiment of the present invention.

Similar reference characters denote corresponding features consistently throughout the attached drawings.

### DETAILED DESCRIPTION OF THE PREFERRED EMBODIMENTS

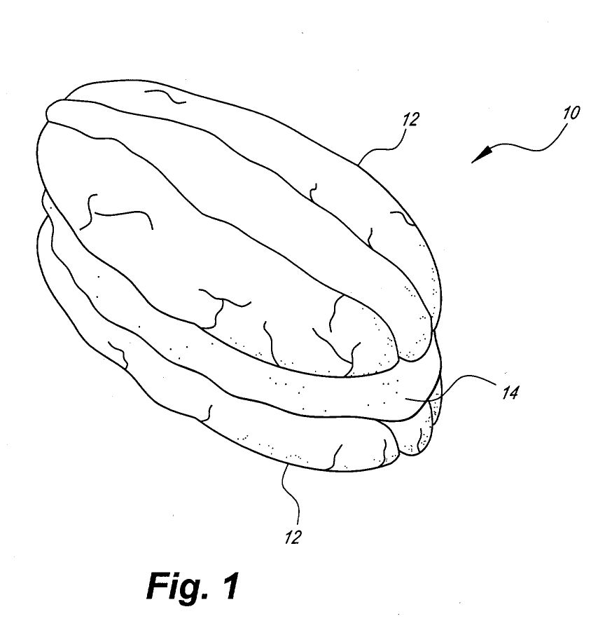

The present invention is directed to a pecan confectionery, generally designated as 10. In the embodiment depicted in FIG. 1, the pecan confectionery 10 includes two overlapping pecan halves 12 and an edible filling layer 14 sandwiched between the two pecan halves 12. (As used in the present application, the term “pecan” refers to the seed obtained by splitting open the shell of a pecan nut, and the term “pecan halves” refers to the halves obtained by splitting the pecan seed longitudinally into two halves.) The filling layer 14 can be any spreadable food product including, but not limited to cream, ice cream, marshmallow, and caramel. While FIG. 1 depicts only two pecan halves 12 adhered together by the filling layer 14, additional pecan halves 12 may be similarly adhered to the pecan confectionery 10 to produce a larger pecan confectionery portion 10, and thereby further facilitate consumption of many pecans at one time.

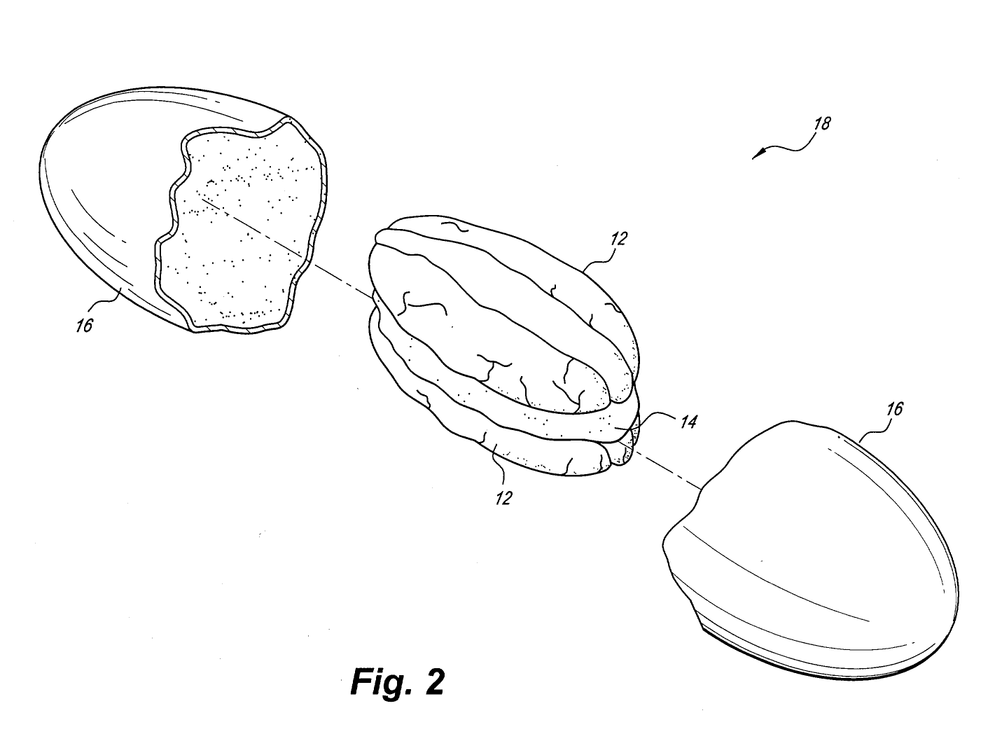

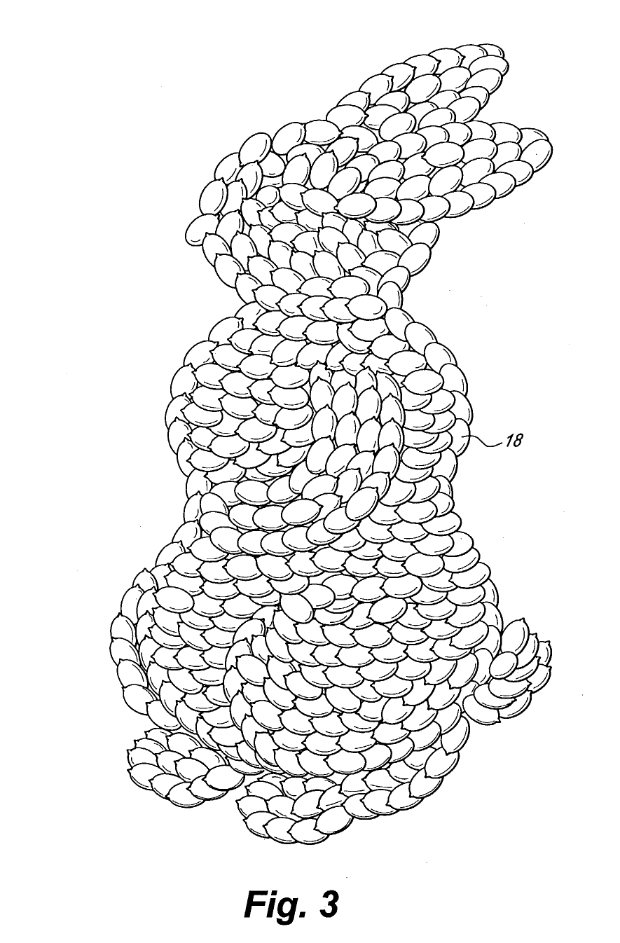

FIG. 2 shows a second embodiment of the pecan confectionery, designated as 18. This embodiment is identical to the pecan confectionery 10, except that it is coated with an edible outer layer 16. The edible outer layer 16 can be chocolate, hard candy, caramel, or any other suitable food product. The edible outer layer 16 can be configured and colored to simulate the outer shell of a pecan. As can be seen in FIG. 3, more than one pecan confectionery 18 may also be adhered together to achieve a desired decorative arrangement.

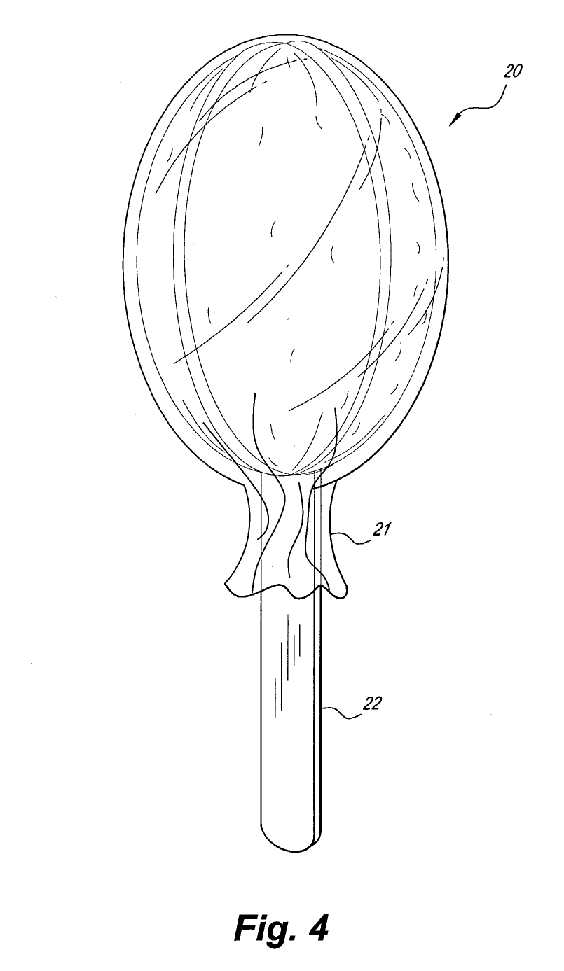

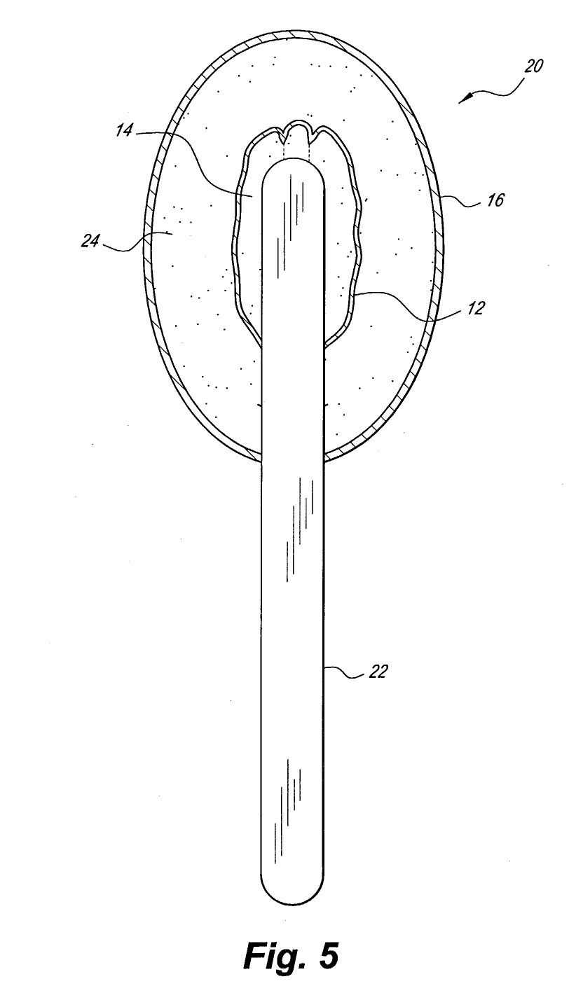

A third embodiment, generally designated as 20, is shown in FIGS. 4-5. FIG. 4 depicts the pecan confectionery 20 wrapped in a plastic wrapper 21 and affixed to a flat stick 22, so that the user does not have to touch the outer layer 16. FIG. 5 depicts a cross-section of the pecan confectionery 20 without the wrapper 21. As can be seen, this embodiment is identical to the pecan confectionery 18, except that an additional edible layer 24 has been added between the pecan halves 12 and the outer layer 16, and except that the confection 20 is supported on the stick 22. While the edible inner layer 24 can be any suitable food product, preferably, the edible inner layer 24 is ice cream. More than one edible inner layer 24 may be provided. As can be seen, the edible inner layer 24 substantially envelops the pecan halves 12, and the edible outer layer 16 substantially coats the edible inner layer 24. The stick 22 extends from the filling layer 14 between the overlapping pecan halves 12 through the edible inner and outer layers 24 and 16. The stick 22 can be made from any suitable material, such as wood or plastic.

It is to be understood that the present invention is not limited to the sole embodiments described above, but encompasses any and all embodiments within the scope of the following claims.

I claim:

1. A pecan confectionery comprising:
at least two pecan halves stacked one upon the other; and
an edible filling layer disposed between said pecan halves, said filling layer joining said pecan halves together and to provide additional flavor.

2. The pecan confectionery of claim 1, wherein said filling layer is cream.

3. The pecan confectionery of claim 1, wherein said filling layer is marshmallow.

4. The pecan confectionery of claim 1, wherein said filling layer is ice cream.

5. The pecan confectionery of claim 1, wherein said filling layer is caramel.

6. The pecan confectionery of claim 1, further comprising an outer edible layer encompassing said pecan halves, said outer edible layer being configured to simulate a pecan shell.

7. The pecan confectionery of claim 6, wherein said outer edible layer is chocolate.

8. The pecan confectionery of claim 6, wherein said outer edible layer is hard candy.

9. The pecan confectionery of claim 6, wherein said outer edible layer is caramel.

10. The pecan confectionery of claim 6, further comprising at least one inner edible layer disposed between said outer layer and said pecan halves.

11. The pecan confectionery of claim 10, wherein said at least one inner edible layer is ice cream.

12. The pecan confectionery of claim 7, further comprising a stick, a portion of said stick extending from said filling layer through said inner edible layer and said outer edible layer, whereby said pecan confectionery is supported on said stick.
